(19) United States
(12) Patent Application Publication
(10) Pub. No.: US 2026/0316802 A1
(43) Pub. Date: Oct. 15, 2026

(54) DOOR SYSTEM HAVING A CLOSURE ELEMENT WITHIN THE OUTER CONTOUR OF THE VEHICLE

(71) Applicant: BODE - DIE TÜR GMBH, Kassel (DE)

(72) Inventor: Lars LINNENKOHL, Staufenberg (DE)

(21) Appl. No.: 19/163,270

(22) PCT Filed: Jan. 9, 2024
(86) PCT No.: PCT/EP2024/050344

§ 371 Date: Sep. 8, 2025

(30) Foreign Application Priority Data
Mar. 9, 2023 (DE) 20 2023 101 132.2
Oct. 30, 2023 (DE) 10 2023 129 904.2

(51) Int. Cl. B61D 19/02; E05F 15/627

(52) U.S. Cl. CPC B61D 19/02; E05F 15/627; E05Y 2900/51

(57) ABSTRACT

A door system for a vehicle, in particular a rail vehicle, for opening and closing a door opening, having at least one door leaf and one closure element, wherein the door leaf and the closure element are designed to close the door opening in a closed state, and to release the door opening in an open state. With the door system,
the closure element is mounted in at least one guide rail adapted substantially to an outer contour of the vehicle in the region of the door opening and is guided and movable therein for closing and opening the door opening.
the at least one guide rail is mounted on the doorway so as to be displaceable in a Z-direction transverse to the main extension of the door opening (X-Z extension).

### CROSS-REFERENCE TO RELATED APPLICATIONS

This application is a 35 U.S.C. § 371 National Stage patent application of PCT/EP 2024/050344 filed 9 Jan. 2024, which claims the benefit of both German patent application 10 2023 129 904.2, filed on 30 Oct. 2023, and German patent application 20 2023 101 132.2, filed on 9 Mar. 2023, the disclosures of which are incorporated herein by reference in their entirety.

### TECHNICAL FIELD

The disclosure relates to a door system for a vehicle, in particular a rail vehicle. The door system is designed to close a door opening by means of at least one door leaf and one closure element.

### BACKGROUND

Door systems for rail vehicles or local public transport vehicles usually comprise one or two door leaves. The door leaves can open or close a door opening or an entry region of the vehicle via a sliding or sliding plug movement. In a sliding plug movement, the door leaves pivot outwards slightly and then move out sideways. In doing so, the door leaves protrude beyond the vehicle outer shell.

In the lower region of the door opening, steps can be extended, for example, which close the gap between the vehicle and a platform and thus make it easier for passengers to board and alight. These steps can also close part of the door opening in the closed state or are concealed by the door leaves or additional flaps in the closed state.

When such door systems are designed, the aim is for the door leaves and additional flaps to protrude as little as possible beyond the vehicle outer shell when open, as otherwise this may result in collisions with the platform, with waiting passengers or with objects left on the platform.

### SUMMARY

The disclosures therefore provides an optimised door system, which has minimal collision risk when open. The door system should be robust and simple in design. Furthermore, the disclosure proposes a method for closing such a closure element. This is achieved by providing a door system having the features of the independent device claim and the independent method claim. Further, particularly advantageous embodiments of the disclosure are disclosed in the respective subclaims.

According to the disclosure, a door system for a vehicle, in particular a rail vehicle, comprises at least one door leaf and one closure element for opening and closing a door opening. The door leaf and the closure element are designed to close the door opening in a closed state, and to release the door opening in an open state. The disclosure is characterised in that the closure element comprises a plurality of slats movably connected to one another for closing part of the door opening.

The door opening is usually substantially rectangular and aligned parallel to a substantially vertical side wall of the vehicle. The width of the door opening extends in the direction of travel of the vehicle and is determined by a horizontally extending upper and a horizontally extending lower limb of the doorway. The height of the door opening is determined by two side limbs of the doorway, which run substantially vertically, but follow the contour of the outer shell of the vehicle, which in particular in an upper and a lower region of the door opening can lead to the side limbs not necessarily running vertically in all spatial directions there. In the lower region of the door opening there is a floor of the passenger compartment of the vehicle, which adjoins the lower limb of the doorway. The door system may comprise a one-piece door frame that is firmly connected to the vehicle and encloses the door opening. The door leaves and the closure element are movably mounted on the door opening or door frame so that they can be moved between the closed and open state by a drive of the door system.

When the door system is opened, the lower region of the door leaves has the highest risk of colliding with the platform or objects on the platform. Therefore, the door leaves of the present disclosure are shortened in the lower region compared to a conventional door system. This means that the lower region of the door opening can no longer be closed by the door leaves. However, this lower region of the door opening can be closed using the closure element.

To close the door opening, the closure element preferably comprises a plurality of slats which are movably connected to one another and which can be moved substantially upwards or downwards along a vehicle contour or vehicle outer shell in the manner of a roller shutter. Within the meaning of the application, substantially upwards or downwards means that although the slats can be moved upwards or downwards, they can follow the vehicle contour, i.e. do not necessarily have to be moved vertically. A key feature is that the closure element or its slats can be moved to below the door opening so that the door opening is released. It is also conceivable that the closure element or the slats are moved horizontally below the door opening and are held in a horizontally extending region below the door opening or entry region.

Instead of slats, a single continuous element is also suitable, for example a type of elastic plastic sheet.

The slats are preferably designed as elongate bodies, whose length is many times the width and depth of the slats. The longitudinal axis extends in the direction of travel of the vehicle when the doors are arranged at the side of the vehicle. The slats are movably connected to one another along their longitudinal axes so that the slats can be rotated or pivoted relative to one another about axes of rotation parallel to the longitudinal axes. In this way, the slats form a kind of shutter blind that can follow the generally two-dimensional outer contour of the vehicle when the closure element is moved along this outer contour.

As a result of the fact the closure element follows the outer contour or outer shell of the vehicle, no component of the door system protrudes beyond the vehicle shell in the lower region of the door opening, considerably reducing the risk of collision with the platform or objects.

In one embodiment of the door system, the slats are connected to one another via a continuous sealing mat. Such a sealing mat can, for example, be made of rubber. Ethylene propylene diene monomer rubber (EPDM) is frequently used in vehicle construction as a robust sealing material such that the sealing mat is preferably made of EPDM. The slats are preferably arranged on the sealing mat spaced apart from one another and firmly connected to the sealing mat. It may be provided that the slats are designed in two parts and the respective one part of the slats is arranged on the one side of the sealing mat, and the respective other part of the slats is arranged on the other side of the sealing mat. The one part of the slats can be very stable and form a supporting part of the slat, while the other part gives the slat an attractive appearance.

In another embodiment of the door system, the closure element is coupled to a drive via at least one, preferably two roller chains. The individual slats are respectively attached at the end to one chain link of the roller chain and are therefore also coupled to one other via the connection of the chain links.

Two roller chains are preferably provided as drive means for the closure element and are guided in guide rails in the door system. Instead of roller chains which have individual rollers, chains without rollers may also be used. The term roller chain is synonymous with both types of chain below. The guide rails can preferably be formed from U-profiles. The roller chains driven by the drive move along the guide rails and thereby move the closure element, preferably in translation, from the closed to the open state and back again. As an alternative to roller chains, other elements with similar properties may also be used as drive means, such as elastic rods made of plastic or metal, which are connected to the closure element or slats via suitable means.

If the closure element is to be guided along the outer contour of the vehicle, the guide rails also follow the outer contour of the vehicle in this region. In the guide rails, the closure element is arranged substantially flush with the outer contour of the vehicle when it is in the closed state. Within the meaning of the application, arranged substantially flush with the outer contour means that, for example, individual slats do not necessarily have to be arranged flush, or the slats may be arranged slightly offset to the outer contour.

The guide rails can be arranged in the lower region of the door opening. The side limbs of the door opening or door frame are ideal for this. The lower region extends, for example, over a bottom third of the door opening, wherein the bottom third extends over the entire width of the door opening and extends from the floor of the vehicle vertically upwards over a third of the height of the door opening.

In one particularly advantageous embodiment, the two parallel guide rails are respectively part of side parts that are mounted to move substantially transversely to the direction of movement of the roller chains. The roller chains can move in the guide rails of the side parts from a closed position to an open position and back. A stationary contact element is respectively provided adjacent to the two side parts, so to speak in the extension of the guide rails, which adjoins the respective side part in the closing direction of the closure element. The contact elements respectively have receptacles formed as recesses opposite the guide rails for at least one chain link. If the closure element is moved into the closed position, the roller chains move out of the guide rails towards the contact elements and are guided into the receptacles.

The receptacles are respectively arranged at an angle to a longitudinal axis of the guide rails. The respectively foremost chain link, which is guided out of the guide rail, comes into contact with a deflection surface of the receptacle and is deflected laterally in the direction of the vehicle interior as it continues to move until a free front end surface of the first chain link abuts a stop surface at the lowest point of the receptacle.

The receptacles are preferably inserted so deep into the contact elements that they can respectively accommodate almost an entire chain link. This allows the first free chain links to be folded to the side.

Instead of receptacles, only deflection surfaces can be provided on which the drive means is deflected.

After the respectively first free chain link has come to rest against the stop surface, further movement of the roller chains in the direction of the stop surfaces causes the first chain links to fold over, applying a force in the transverse direction to the respective guide rails. As the two side parts are mounted so that they can move in a transverse direction, the force acting on inner walls of the guide rails causes the two side parts and thus the roller chains and slats guided therein to move transversely to the longitudinal course of the roller chains. Thanks to this transverse movement, the closure element can preferably be pressed from the inside against door seals that are arranged in the doorway, thereby ensuring a high sealing performance. Bulb seals have proven particularly suitable as door seals, for example. The possibility of transverse movement of the side parts can be ensured, for example, by the fact that they are screwed to the doorway using screws, wherein the screws extend through slotted holes in the side parts.

The transverse movement of the guide rails or side parts and closure elements depends on the length of the folding chain links and/or the depth of the recesses. The travel path of the side parts and thus the closure element can thus be adjusted by adapting the geometry. It has been shown that a travel path of around 4 mm to 10 mm, preferably 5 mm to 6 mm is sufficient to achieve satisfactory sealing of the door.

Springs elements are preferably provided and are arranged between the stationary doorway and the guide rails and/or the displaceable side parts. When the door opening is closed, the guide rails or side parts are moved against the spring force in the direction of the sealing elements; when it is opened, the spring elements drive the guide rails or side parts back to their starting position again.

The slats can be connected to one another via the continuous sealing mat and additionally or else exclusively via hinges. The use of hinges means that the slats can only move relative to one other around defined axes of rotation. This can, for example, be advantageous if the slats connected to one another are to be moved in a sliding manner. If the slats are not connected to one other via defined axes of rotation, the slats could easily twist or tilt unintentionally when they are moved.

It is also conceivable that the slats form the hinges themselves, for example by means of slats with suitable cross-sections or hollow profiles, such that the slats can be inserted into one another and insertion regions formed thereby respectively form a hinge.

If the hinges are used in addition to the sealing mat, the hinges can ensure that the slats can move relative to one another as desired, whilst the sealing mat connects the slats to form a closed and preferably air-tight surface while allowing the necessary range of motion between the slats.

In another embodiment of the door system, the at least one door leaf together with the closure element closes the door opening in a substantially pressure-tight manner such that a vehicle interior is sealed from the vehicle exterior to withstand pressure shocks.

In rail vehicles with a door system that is not pressure-tight, an unpleasant pressure shock occurs for passengers when entering tunnels or passing trains due to overpressure or underpressure. Within the meaning of the application, substantially pressure-tight means that pressure shocks that occur, for example when a rail vehicle enters a tunnel, cannot reach the vehicle interior through the door opening, or only to a greatly reduced extent.

When the door leaves close the door opening, their main closing edges touch. In the case of single-leaf door systems, the main closing edge is located on the front door leaf edge in the closing direction. A secondary closing edge of the door leaf is arranged at the rear on the closing side. The main closing edge and the secondary closing edge of a door leaf extend over the entire height of the door leaf.

In the closed state, the door leaves are usually locked passively at the main closing edge and actively at the secondary closing edge. Passive locking at the main closing edge can be realised by the door leaf sliding behind passive locking elements at the door opening, such as alignment wedges. The passive locking elements are usually distributed over the entire height of the door leave in order to be able to absorb the operating forces that occur while minimising deformation of the door leaf. In addition, the door opening or door frame and a frame of the door leaf are designed to be particularly rigid, which also reduces deformation of the door leaf.

As with the door leaves, the closure element is also designed to be suitably rigid in order to withstand the pressure forces caused by the aforementioned pressure shocks. This can, for example, be achieved through slats with a rigid cross-sectional profile or through reinforcements in or on the slats. Hollow cross-sections, in particular rectangular or oval hollow profiles, are ideal for this. Two-part slats can also fulfil this purpose, with one part of the slat being designed as a rigid and supporting part and the other part giving the slat an attractive appearance.

Sealing between the door leaf and door opening or door frame can be achieved by a seal arranged on the door leaf. A seal is also provided at the point of contact between the door leaf and closure element so that the entire door opening can be closed in a pressure-tight manner by the door leaves and closure element.

Instead of the seals, suitable entry profiles can also be provided on the door opening or door leaves, into which the door leaves and closure element can move and create the seal there, for example via a preloaded line contact.

The closure element closes a substantially rectangular part of the door opening such that the closure element or its slats also form a substantially rectangular flat element in the closed state, wherein this flat element follows the outer contour of the vehicle, i.e. can follow a curvature, for example. In the closed state, the closure element has a horizontally extending upper edge, a horizontally extending lower edge and two lateral edges extending from top to bottom, which respectively connect the upper to the lower edge. It is therefore suitable for the closure element to be sealed against the door opening or door frame in the closed state with the aid of a lateral sealing arrangement in the region of the lateral edges of the closure element.

Likewise, the closure element can be sealed at an upper end in the region of the upper horizontally extending edge of the closure element against the at least one door leaf in the closed state via an upper sealing arrangement. The door leaf is thereby arranged above the closure element and closes an upper part of the door opening in the closed state, whilst the closure element closes a lower part of the door opening in the closed state. This results in a contact region between the door leaf and closure element, which can be sealed as proposed.

The closure element can also be sealed to the door opening or door frame at the horizontal lower edge of the closure element. For this purpose, the closure element is sealed at a lower end of the closure element against the door opening or door frame in the closed state via a lower sealing arrangement. These and other seals can preferably be designed as bulb seals. Bulb seals are hollow profiles made of sealing material, such as rubber or EPDM, which are compressed between two components to achieve the sealing effect. They can deform in the process and thus fit against the components and seal the contact region.

It is also conceivable that the sealing arrangements are moved towards the closure element in the closed state and thus preloaded against the closure element. It is important that the sealing arrangements are preloaded against the closure element in order to be able to achieve their sealing effect.

In addition to the lateral receptacles, one or more alignment wedges may also run over the entire length of the closure element in the direction of travel such that the closure edge is deflected over the entire length.

Another possibility is that the alignment wedge is movably mounted and is moved by the insertion of the closure edge. This movement of the alignment wedge can be used to preload one of the sealing arrangements, preferably the lateral sealing arrangement, against the closure element. For this purpose, a lever mechanism may be provided between the alignment wedge and the sealing arrangements to transmit the movement.

In another embodiment of the door system, the closure element is designed in such a way that it is arranged within a vehicle outer shell both in the closed and in the open state, as well as in all states between the closed an open state.

The vehicle shell is formed by the outer contour of the vehicle. In rail vehicles or buses, this vehicle shell is usually formed of a roof region, a floor region and two side surfaces running vertically between these two regions. The vehicle shell can also be referred to as the outer contour.

As the platform or objects may be in the way when the door system is opened especially in the lower region of the door opening, it is all the more important the closure element protrudes as little as possible beyond the vehicle shell in the lower region of the door opening. The closure element can therefore be designed and guided in such a way that it does not protrude beyond the vehicle shell either in the closed or in the open state. Thanks to the slat design of the closure element, the closure element can also be designed and guided in such a way that it does not protrude beyond the vehicle shell in any state between the open and closed state either, for example thanks to guide rails for the slats which follow the vehicle shell or vehicle contour.

In another embodiment of the door system, the closure element is coupled to a drive of the door system, which drives the closure element and can move it between the closed and open state. The drive of the door system therefore also preferably serves to drive the at least one door leaf.

The method according to the disclosure for opening and closing a door opening of a vehicle has the following method steps for closing the door opening:
moving the drive means in the guide rail towards the door leaf and thereby moving the closure element,
moving a free end of the drive means into a receptacle arranged in a contact element adjacent to the guide rail, wherein the receptacle has a deflection surface arranged at an angle to the course of the guide rail,
further moving the drive means, whilst the free end of the drive means is deflected in the direction of a vehicle interior by the deflection surface until the free end comes to rest against a stop surface in the receptacle, wherein a drive force of the drive means is deflected by contact with the receptacle and drives the guide rail in the Z-direction transverse to the main extension of the door opening (X-Z extension).

### BRIEF DESCRIPTION OF THE DRAWINGS

Further advantageous and preferred embodiments will result from the following description with reference to the figures. In the drawings, which only show one exemplary embodiment

FIG. 1 shows a door system from the prior art,

FIG. 2 shows a door system having a closure element with slats movably connected to one another, arranged in a lower region of the door opening,

FIG. 3 shows the closure element shown in FIG. 2 in a closed state,

FIG. 4 shows the closure element shown in FIG. 2 in an open state,

FIG. 5 shows a guide rail and a lateral sealing arrangement for the closure element,

FIG. 6-10 show vertical sectional views through the closure element to illustrate the movement of components of the closure element, and

FIG. 11 shows a vertical sectional view through the closure element in the closed state.

### DETAILED DESCRIPTION OF THE DRAWINGS

FIG. 1 shows a door system of a rail vehicle from the prior art having a door leaf 21 and a foldable closure element 22. Together with the closure element 22, the door leaf 21 can close a door opening in a closed state and open it in an open state.

The door opening is a substantially rectangular opening with a horizontal upper limb, a horizontal lower limb, and two side limbs running substantially vertically, wherein the two side limbs follow the outer contour of the rail vehicle and therefore in particular in the upper and lower region of the door opening do not necessarily run vertically in all spatial directions. The horizontal upper and horizontal lower limb run parallel to the direction of travel 23 of the vehicle.

The door opening is incorporated into an outer shell of the rail vehicle, wherein both the door leaf 21 and the closure elements 22 are adapted to this contour such that they are arranged flush with the outer shell of the vehicle in the closed state. In FIG. 1, the door leaf 21 is in the closed state, whilst the closure element 22 is in the open state for illustrative purposes. It can clearly be seen that the closure element 22 from the prior art protrudes significantly beyond the outer shell of the vehicle in the open state. The door leaves 21 also protrude significantly beyond the outer shell of the vehicle in the open state, as the door leaves 21 perform a sliding plug movement when opened, during which they initially pivot outwards slightly from the outer shell transverse to the direction of travel 23, and then move out sideways parallel to the direction of travel 23 and open the door opening. The lower region of the door leaves 21 risks colliding with the platform or objects left on the platform.

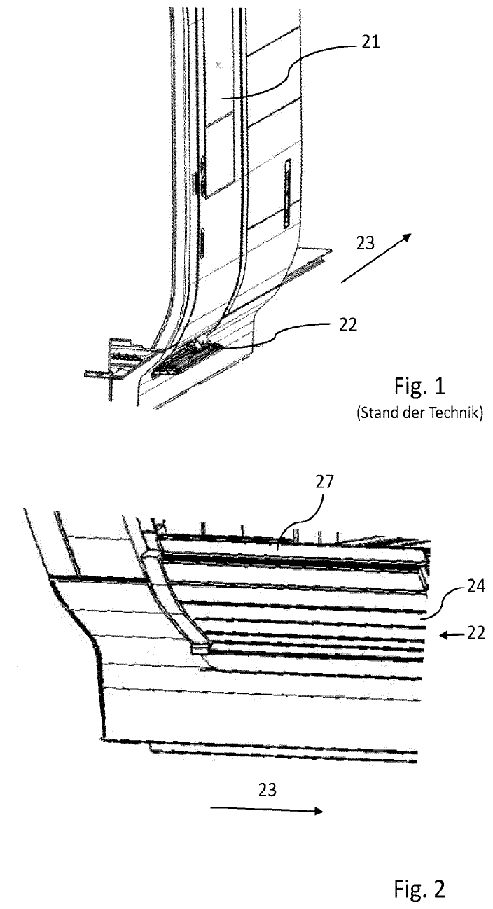

This is where the disclosure comes in. In the door system according to the disclosure shown in FIG. 2, the door leaves 21 are shortened in the lower region compared to the prior art shown in FIG. 1 meaning that the door leaves 21 are at less risk of collision. If the closure element 22 from the prior art shown in FIG. 1 were simply extended in order to close the part of the door opening which is no longer closed by the door leaves 21 due to the shortening of the door leaves 21, the closure element 22 would protrude significantly further beyond the outer shell of the vehicle, which should, however, be avoided.

The closure element 22 according to the disclosure in accordance with FIG. 2 comprises a plurality of slats 24 movably connected to one another, which are guided via roller chains 37 in two guide rails 25 arranged opposite one another in the door opening. The guide rails 25 are arranged at the side of the door opening in movably mounted side parts 40 and follow the contour of the vehicle or the outer shell of the vehicle.

The closure element 22 can be moved up and down along the guide rails 25 between the closed state and the open state by a drive of the door system. As the guide rails 25 follow the contour of the vehicle, the closure element 22 does not protrude beyond the outer shell of the vehicle at any point, eliminating the risk of collision.

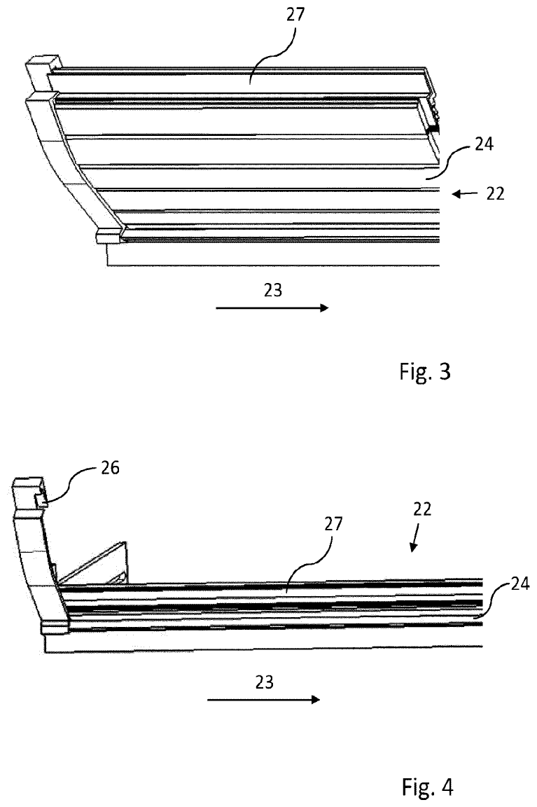

FIG. 3 shows the closure element 22 in the closed state. The slats 24 are moved upwards for this purpose.

FIG. 4 shows the closure element 22 in the open state in which the slats 24 are moved downwards.

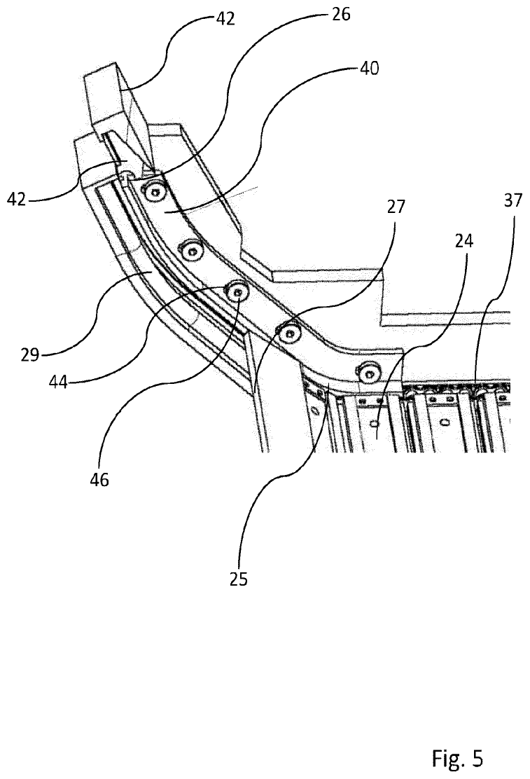

FIG. 5 shows the closure element 22 also in the open state, but from another perspective. This perspective shows one of the side parts 40 which has a guide rail 25 more clearly. At the upper left end of the guide rail 25 shown in FIG. 5, a receptacle 26 is fitted, into which a first free chain link 38, i.e. the front chain link in the direction of travel of the roller chain 37, moves during closing. The receptacle 26 is arranged in a stationary contact element 42 (cf. following figures).

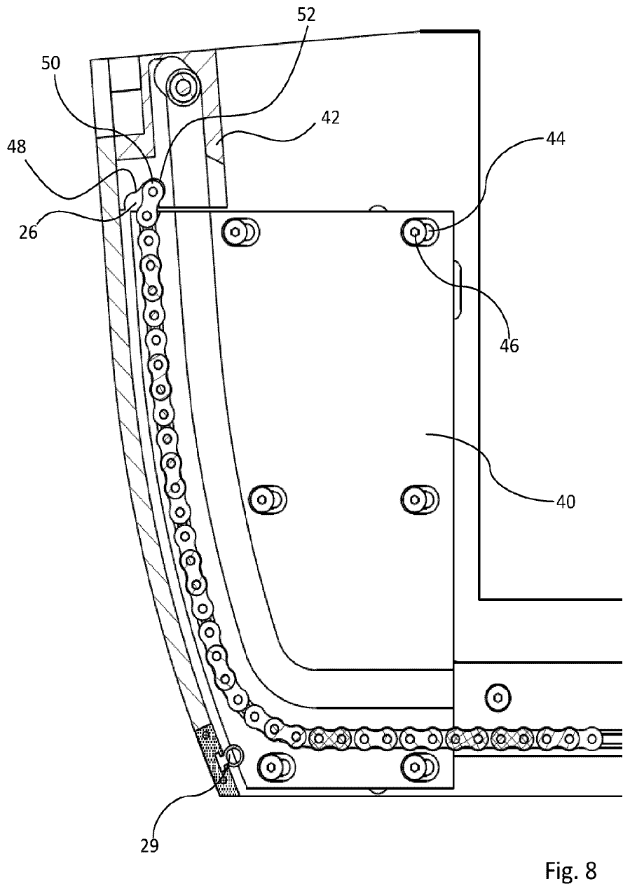

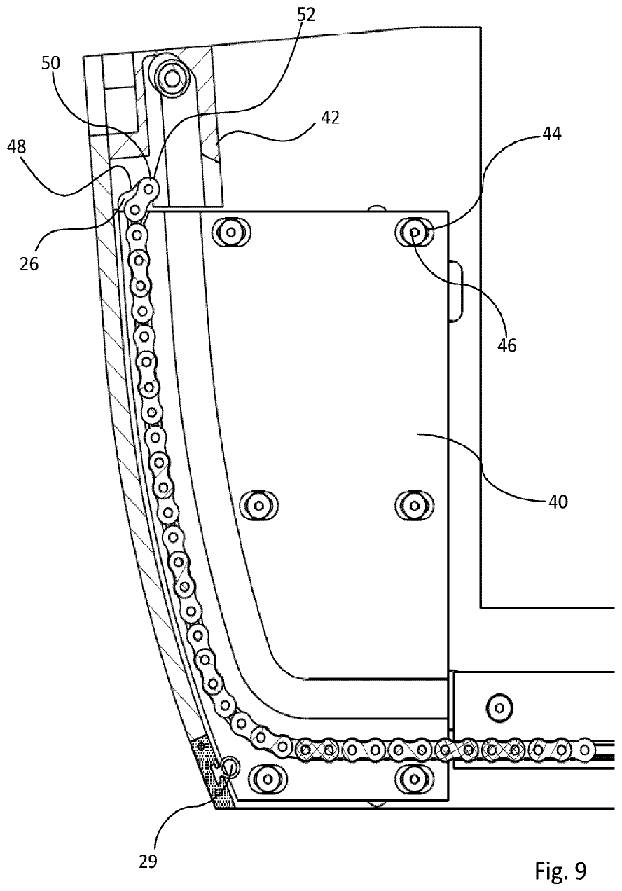

The receptacle 26 is designed in such a way that the first chain link 38 undergoes a tilting movement or rotation, which causes the roller chain 37 to move the guide rail 25 or the side part 40 in the direction of a lateral sealing arrangement. A bulb seal 29 is provided as the sealing arrangement in the exemplary embodiment shown, against which the side part 40 is pressed, enabling the bulb seal 29 to establish the sealing effect. As shown in particular in FIG. 5, the bulb seal 29 can be arranged along the route of the roller chains 37 or the slats 24; however, a bulb seal 29 can also or additionally be provided which runs transverse to the route of the roller chains 37, as shown in particular in FIGS. 4-10.

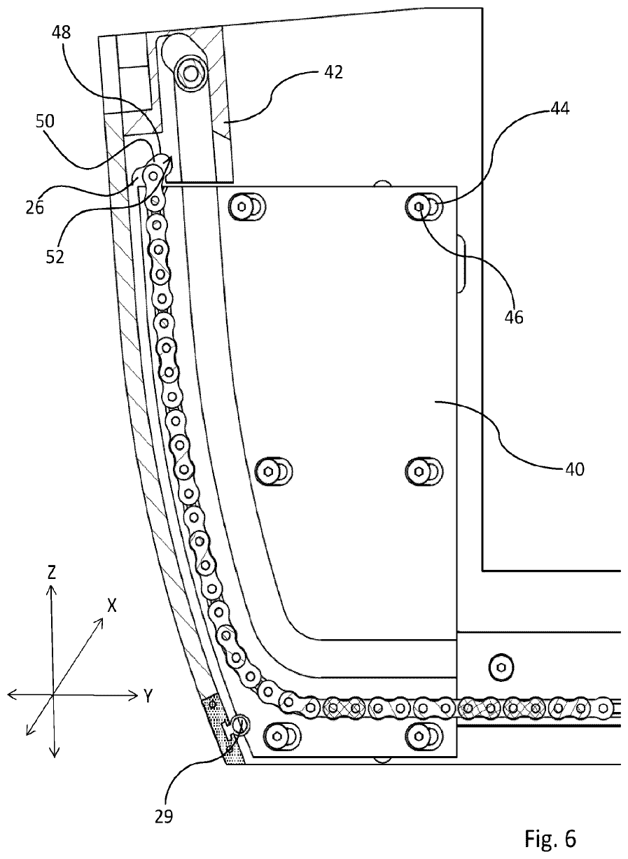

FIGS. 6 to 10 show vertical sectional views through the closure element 22 to illustrate the mechanics and movement of the different components.

The plane of the door opening extends along the X and Z directions, where Z is the vertical axis of the vehicle, and X runs parallel to the outer wall of the vehicle. FIG. 6 shows a corresponding directional diagram.

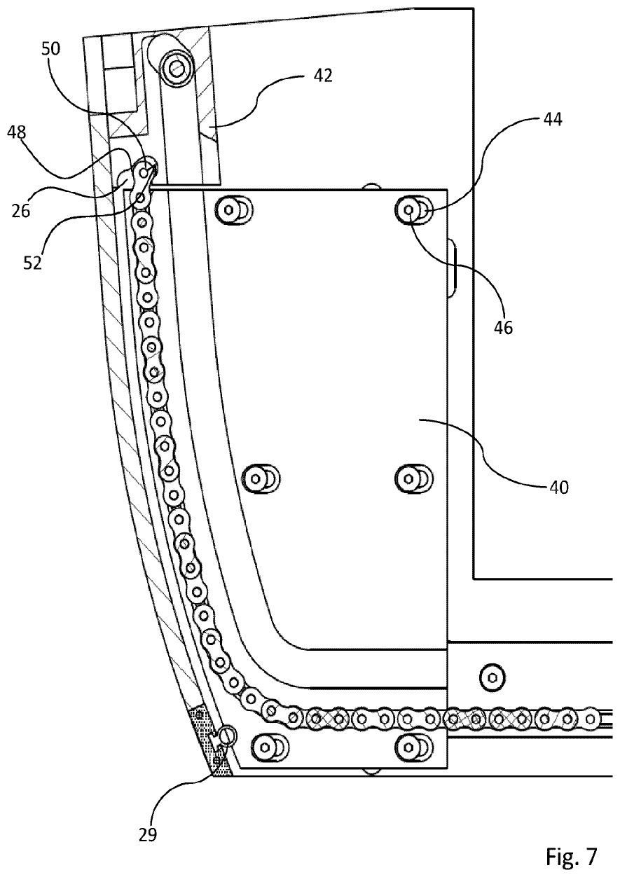

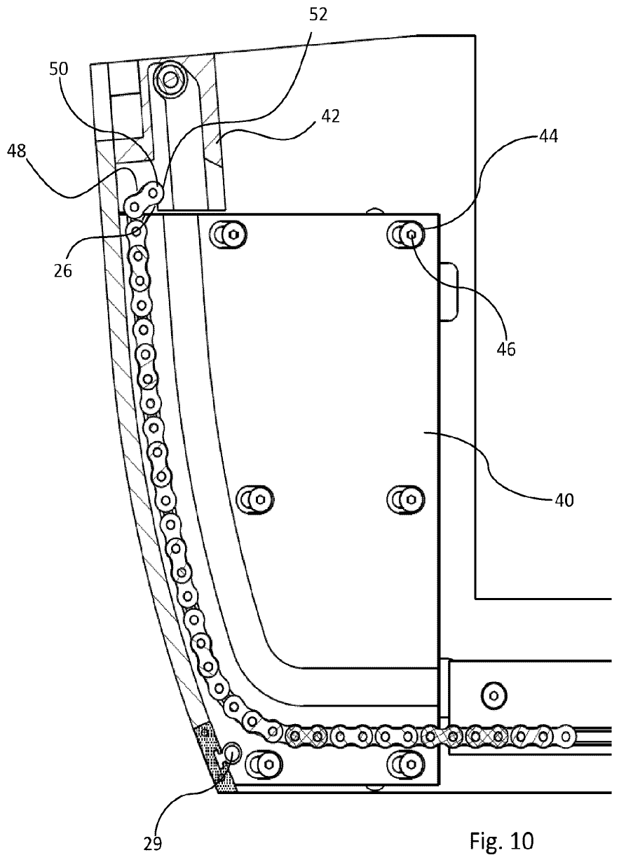

It shows one of the two side parts 40 with the associated roller chain 37 in the guide rail 25 (not shown) and the adjacent stationary contact element 42. FIG. 6 shows the state before the sealing effect has been achieved by moving the side part 40, FIG. 10 shows the end position with complete sealing effect. FIGS. 7, 8 and 9 respectively show intermediate positions.

It can be seen that the side part 40 has slotted holes 44, through which screws 46 extend. The slotted holes enable the side part 40 to move in the Y direction, i.e. in the direction of the bulb seal 29 arranged in the lower region and extending transverse to the direction of travel of the side part 40.

In the state according to FIG. 6, the roller chains 37 are just before their end position, the opening below the door leaves 21 is already largely closed by the closure element 22 or the slats 24. The foremost chain link 38 in the closing direction has already moved about halfway out of the guide rail 25 or side part 40 and comes to rest against a deflection surface 48 of the receptacle 26.

The following figures show that the foremost chain link 38 is deflected laterally in the direction of the vehicle interior as the roller chains 37 continue to move until a free front end surface 50 of the foremost chain link 38 comes to rest against a stop surface 52 at the lowest point of the receptacle 26.

In the exemplary embodiment shown, the receptacle 26 shown is inserted so deep into the contact element 42 that it can accommodate almost the entire foremost chain link 38. In the end position, the rear chain link axis of rotation of the foremost chain link 38 in the closing direction is arranged outside the guide rail or side part 40 and outside the contact element 42, i.e. between these, which makes it possible to fold the foremost chain link 38 to the side. In an alternative embodiment, a plurality of chain links can also be inserted into the receptacle 26; it is only essential that a chain link axis of rotation is arranged outside the receptacle 36 and outside the contact element 42.

After the foremost chain link 38 has come to rest against the stop surface 52, further movement of the roller chain 37 in the direction of the stop surface 52 causes the foremost chain link 38 to fold over, applying a force in the transverse direction to the guide rail 25. As the side part 40 is mounted so that it can move in a transverse direction, the force acting on an inner wall of the guide rail 25 causes the side part 40 and thus the roller chain 37 and slats 24 guided therein to move transversely to the longitudinal course of the roller chain 37. The closure element 22 is pressed against the bulb seal 29 due to this transverse movement. In the end position (FIG. 10), the foremost chain link 38 also lies almost completely in the receptacle 26 or on the stop surface 52 with its side surface pointing in the direction of travel of the roller chain 37.

A travel path of around 6 mm has proven particularly suitable, wherein this stroke may also be greater or smaller.

At least one spring element, which exerts a restoring force on the displaceable side parts, is not shown. When the door opening is closed, the guide rails or side parts are moved against the spring force from their starting position in the direction of the sealing elements into an end position; when it is opened, the spring elements drive the guide rails or side parts back to their starting position again. The drive force for the movement of the roller chain 37 is deflected by folding over the foremost chain link 38 and overcomes the spring force of the spring element when the roller chain 37 is moved. A plurality of spring elements are preferably provided and distributed along the course of the roller chain 37 in the side part 40 between a stationary component in the doorway and the side part 40.

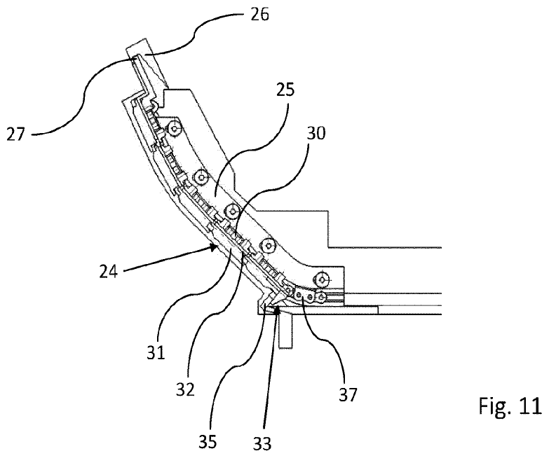

FIG. 11 once again shows the closure element 22 having slats 24 in the closed state in a sectional view in a slightly modified embodiment of the disclosure. Unlike the embodiment shown in FIGS. 6 to 10, a lower sealing arrangement 33 having a lower sealing lip 34 is located on the lower limb of the door opening. When approaching the closed state, the lower sealing lip moves against a stop 35 on the door opening such that the lower sealing lip 34 is preloaded against the stop 35 and its sealing function is initiated.

The slats 24 of the closure element 22 are respectively composed of a mechanically highly robust, load-bearing support structure 30 on the inside and a covering 31 on the outside. A flexible sealing mat 32 made of rubber is arranged between the support structure 30 and the covering 31 and respectively fixedly connects a support structure 30 to an associated covering 31. The slats 24 are therefore movably connected to one another via the sealing mat 32.

1. Door system for a vehicle, in particular a rail vehicle, for opening and closing a door opening, having at least one door leaf (21) and one closure element (22), wherein the door leaf (21) and the closure element (22) are designed to close the door opening in a closed state, and to release the door opening in an open state,
characterised in that
the closure element (22) is mounted in at least one guide rail (25) adapted substantially to an outer contour of the vehicle in the region of the door opening and is guided and movable therein for closing and opening the door opening,
the at least one guide rail (25) is mounted on the doorway so as to be displaceable in a Z-direction transverse to the main extension of the door opening (X-Z extension).

2. Door system according to claim 1, characterised in that the closure element (22) is connected to a drive means guided in the guide rail (25) and is driven by this to close and open the door opening.

3. Door system according to claim 2, characterised in that the closure element (22) is connected to two drive means, which are respectively arranged in guide rails (25) which run parallel to one another on vertically extending limbs of a doorway delimiting the door opening.

4. Door system according to one of claims 1 to 3, characterised in that a stationary contact element (42) is provided adjacent to the guide rail (25) in such a way that a front free end of the drive means can extend into a receptacle (26) arranged in the contact element (42), wherein the receptacle (26) is designed and arranged with a deflection surface (48) arranged at an angle to the course of the guide rail (25) and a stop surface (52) in such a way that the free end of the drive means is deflected in the direction of a vehicle interior by the deflection surface (48) when the door opening is closed until the free end comes to rest against the stop surface (52) in the receptacle (26), wherein a drive force of the drive means is deflected by contact with the receptacle (26) and drives the guide rail (25) in the Z-direction transverse to the main extension of the door opening (X-Z extension).

5. Door system according to one of claims 2 to 4, characterised in that the drive means is formed by a roller chain (37) and at least one free foremost chain link (38) can be moved in the receptacle, wherein there is then a chain link axis of rotation between the guide rail (25) and the contact element (42).

6. Door system according to one of the preceding claims, characterised in that at least one spring element is provided between a stationary component in the doorway and the side part (40), which drives the guide rail (25) from an end position, in which the door opening is closed, back into the starting position.

7. Door system according to one of the preceding claims, characterised in that sealing elements are provided, via which the at least one door leaf (21) together with the closure element (22) closes the door opening in a pressure-tight manner such that a vehicle interior is sealed from the vehicle exterior to withstand pressure shocks.

8. Door system according to one of the preceding claims, characterised in that a bulb seal (29) is designed and arranged in such a way that, in the closed position of the closure element (22), it seals the closure element (22) against the doorway.

9. Door system according to one of the preceding claims, characterised in that the closure element (22) comprises a plurality of slats (24) movably connected to one another.

10. Door system for a vehicle, in particular a rail vehicle, for opening and closing a door opening, having at least one door leaf (21) and one closure element (22), wherein the door leaf (21) and the closure element (22) are designed to close the door opening in a closed state, and to release the door opening in an open state,
characterised in that the closure element (22)
is mounted in at least one guide rail (25) adapted substantially to an outer contour of the vehicle in the region of the door opening and is guided and movable therein for closing and opening the door opening,
and comprises a plurality of slats (24) movably connected to one another.

11. Door system according to claim 9 or claim 10, characterised in that the slats (24) are connected to one another via a flexible sealing mat (32).

12. Door system according to one of claims 9 to 11, characterised in that the slats (24) are connected to one another via hinges.

13. Door system according to one of the preceding claims, characterised in that the closure element (22) is designed in such a way that it is arranged within a vehicle outer shell both in the closed and in the open state, as well as in all states between the closed an open state.

14. Method for opening and closing a door opening of a vehicle, in particular a rail vehicle having at least one door leaf (21) and one closure element (22), wherein the door leaf (21) and the closure element (22) are designed to close the door opening in a closed state, and to release the door opening in an open state, wherein the closure element (22) is mounted in at least one guide rail (25) and is guided and movable therein via a drive means for closing and opening the door opening, and the at least one guide rail (25) is mounted on the doorway so as to be displaceable in a Z-direction transverse to the main extension of the door opening (X-Z extension), having the method steps for closing the door opening:
moving the drive means in the guide rail (25) towards the door leaf and thereby moving the closure element (22),
moving a free end of the drive means into a receptacle arranged in a contact element (42) adjacent to the guide rail (25), wherein the receptacle (26) has a deflection surface (48) arranged at an angle to the course of the guide rail (25),
further moving the drive means, whilst the free end of the drive means is deflected in the direction of a vehicle interior by the deflection surface (48) until the free end comes to rest against a stop surface (52) in the receptacle (26), wherein a drive force of the drive means is deflected by contact with the receptacle (26) and drives the guide rail (25) in the Z-direction transverse to the main extension of the door opening (X-Z extension).
